(19) United States
(12) Patent Application Publication
(10) Pub. No.: US 2026/0302902 A1
(43) Pub. Date: Oct. 1, 2026

(54) METHOD OF MANUFACTURING ELECTRIC MOTOR AND ELECTRIC MOTOR

(71) Applicant: TOYOTA JIDOSHA KABUSHIKI KAISHA, Toyota-shi (JP)

(72) Inventors: Masanobu HIRAYAMA, Nagoya-shi (JP); Yasunori SUZUKI, Kasugai-shi (JP); Hironori ASAOKA, Okazaki-shi (JP); Kenta INUZUKA, Ayase-shi (JP); Norihiro USHIDA, Numadu-shi (JP); Jun KAWAKAMI, Nishio-shi (JP); Fumiaki YAMATO, Okazaki-shi (JP); Kohei WATANABE, Okazaki-shi (JP)

(73) Assignee: TOYOTA JIDOSHA KABUSHIKI KAISHA, Toyota-shi (JP)

(21) Appl. No.: 19/549,208

(22) Filed: Feb. 25, 2026

(30) Foreign Application Priority Data
Mar. 31, 2025 (JP) 2025-057714

(51) Int. Cl. H02K 15/047; H02K 3/12

(52) U.S. Cl. CPC H02K 15/047; H02K 3/12

(57) ABSTRACT

In a first step of manufacturing method of an electric motor, a lead wire of a stator coil and a tip portion of a bus bar are welded while being held in parallel. In the second step, a varnish receiving member having a through hole through which a welded portion between the lead wire and the bus bar passes and a slot connected to the through hole. The welded portion is passed through the through hole of the varnish receiving member, and then the lead wire and the bus bar are moved to an end of the slot. In the third step, a fluid varnish is applied to the welded portion while holding the welded portion and the varnish receiving member in a posture in which the welded portion is positioned above the varnish receiving member, and the varnish is solidified.

### CROSS-REFERENCE TO RELATED APPLICATION

This application claims priority to Japanese Patent Application No. 2025-057714 filed on Mar. 31, 2025. The disclosure of the above-identified application, including the specification, drawings, and claims, is incorporated by reference herein in its entirety.

### BACKGROUND

### 1. Technical Field

The technology disclosed in the present specification relates to a method of manufacturing an electric motor and to an electric motor.

### 2. Description of Related Art

Lead wires of a stator coil of an electric motor are welded to bus bars. A varnish is applied to the welded portion between the lead wires and the bus bars, in order to reinforce (or protect) the welded portion (for example, Japanese Unexamined Patent Application Publication No. 2019-115170 (JP 2019-115170 A)).

### SUMMARY

When a varnish is applied to the welded portion, a part of the varnish before being solidified may drip onto a stator or the like. The present specification provides a method of manufacturing an electric motor, the method being able to reduce the amount of a varnish that drips onto a stator core or the like. The present specification further provides an electric motor that reduces the amount of a varnish that drips down.

A first aspect of the present disclosure relates to a method of manufacturing an electric motor including a first step, a second step, and a third step. The first step includes welding a lead wire of a stator coil and a tip portion of a bus bar while holding the lead wire and the tip portion in parallel with each other. The second step includes preparing a varnish receiving member having a slot having a width smaller than that of a welded portion between the lead wire and the bus bar and larger than those of the lead wire and the bus bar, and attaching the varnish receiving member such that the lead wire and the bus bar pass through the slot. The third step includes applying a varnish that is fluid to the welded portion while holding the welded portion and the varnish receiving member in a posture in which the welded portion is positioned above the varnish receiving member, and solidifying the varnish.

According to the method of manufacturing an electric motor of the first aspect as described above, the varnish receiving member receives the dripping varnish. Therefore, it is possible to reduce the amount of a varnish dripping onto the stator core or the like, compared to conventional manufacturing methods in which a varnish receiving member is not employed.

In the method of manufacturing an electric motor according to the first aspect of the present disclosure, the varnish receiving member may have a through hole connected to the slot, the through hole being shaped to be sized to allow passage of the welded portion. In this case, the second step may include passing the welded portion through the through hole and then moving the lead wire and the bus bar into the slot. The through hole may be circular in shape. According to the method of manufacturing an electric motor configured as described above, the lead wire and the bus bar can be easily guided into the slot.

In the method of manufacturing an electric motor according to the first aspect of the present disclosure, In the second step, the varnish receiving member may be moved with the welded portion fixed, or the welded portion may be moved with the varnish receiving member fixed.

In the method of manufacturing an electric motor according to the first aspect of the present disclosure, the slot of the varnish receiving member may be open at one end. In this case, the second step may include placing the lead wire and the bus bar into the slot through the one open end. According to the method of manufacturing an electric motor configured as described above, the lead wire and the bus bar can be easily guided into the slot.

In the method of manufacturing an electric motor according to the first aspect of the present disclosure, the varnish receiving member may have a depression depressed from an upper surface of the varnish receiving member. In this case, the third step may include applying the varnish in a state in which the varnish receiving member is held such that the depression is positioned below the welded portion in a vertical direction. According to the method of manufacturing an electric motor configured as described above, the varnish that drips down along the bus bar or the lead wire is collected in the depression, and thus the amount of the varnish that drips down from the varnish receiving member can be effectively reduced.

A second aspect of the present disclosure relates to an electric motor including a stator coil, a bus bar, and a varnish receiving member. A tip portion of the bus bar is welded to a lead wire of the stator coil. The varnish receiving member has a slot having a width smaller than that of a welded portion between the lead wire and the bus bar and larger than those of the lead wire and the bus bar, the bus bar and the lead wire passing through the slot. The welded portion between the bus bar and the lead wire and a part of the slot are covered with a varnish.

In the electric motor according to the second aspect of the present disclosure, the varnish receiving member may have a through hole connected to the slot, the through hole being shaped to be sized to allow passage of the welded portion. The through hole may be circular in shape. According to the electric motor configured as described above, the lead wire and the bus bar can be easily guided into the slot, as described above.

In the electric motor according to the second aspect of the present disclosure, the slot of the varnish receiving member may be open at one end. According to the electric motor configured as described above, the lead wire and the bus bar can be easily guided into the slot, as described above.

In the electric motor according to the second aspect configured as described above, the varnish receiving member may have a depression depressed from an upper surface of the varnish receiving member. According to the electric motor configured as described above, the varnish that drips down along the bus bar or the lead wire is collected in the depression, and thus the amount of the varnish that drips down from the varnish receiving member can be effectively reduced, as described above.

Details and further improvements of the technology disclosed in the present specification will be described in the “DETAILED DESCRIPTION OF EMBODIMENTS” below.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a plan view of an electric motor with a cover removed according to a first embodiment of the present disclosure;

FIG. 2 illustrates a method (first step) of manufacturing the electric motor;

FIG. 3 illustrates the method (second step) of manufacturing the electric motor according to the first embodiment of the present disclosure;

FIG. 4 illustrates the method (third step) of manufacturing the electric motor according to the first embodiment of the present disclosure;

FIG. 5 is a plan view of a varnish receiving member according to a modification of the first embodiment;

FIG. 6 is a cross-sectional view of the varnish receiving member taken along the line VI-VI in FIG. 5;

FIG. 7 is a plan view of an electric motor with a cover removed according to a second embodiment;

FIG. 8 illustrates a method (second step) of manufacturing the electric motor according to the second embodiment;

FIG. 9 is a plan view of a varnish receiving member according to a modification of the second embodiment; and

FIG. 10 is a cross-sectional view of the varnish receiving member taken along the line X-X in FIG. 9.

### DETAILED DESCRIPTION OF EMBODIMENTS

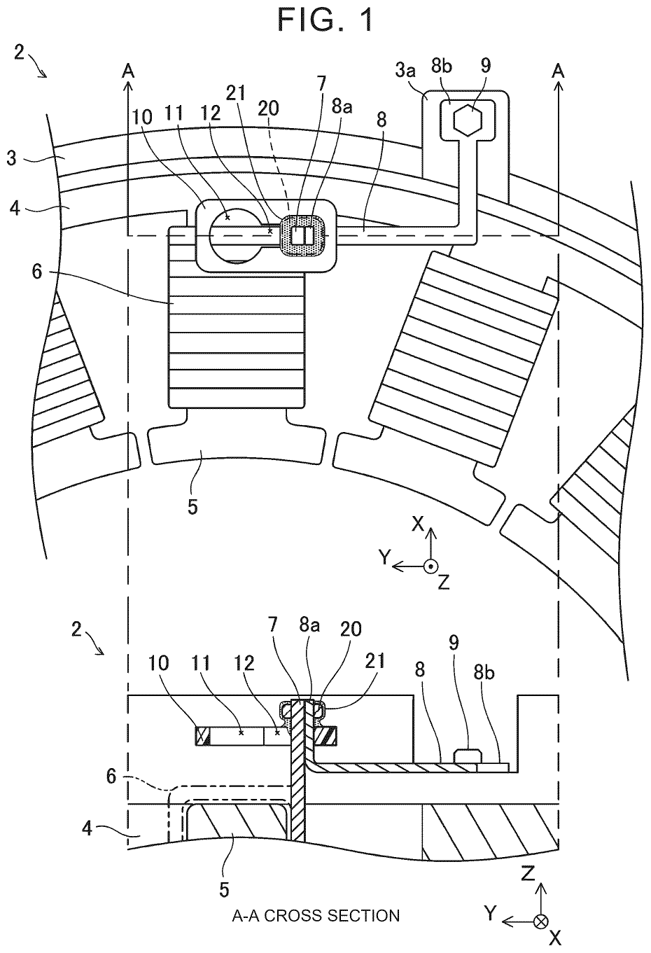

An electric motor 2 according to a first embodiment will be described with reference to the drawings. Hereinafter, for convenience of description, the “electric motor” will be referred to simply as a “motor.” The upper part of FIG. 1 illustrates a plan view of the motor 2. FIG. 1 is a plan view of the motor 2 with a cover removed. The motor 2 includes a cylindrical housing 3 and a stator core 4 housed in the housing 3. The Z axis of the coordinate system in the drawings coincides with the axial direction of the housing 3 and the stator core 4. The XY plane corresponds to a plane orthogonal to the axis of the stator core 4. In FIG. 1, only a part of the housing 3 and the stator core 4 is illustrated. A rotor is illustrated in FIG. 1.

A plurality of teeth 5 is arranged in the circumferential direction at the inner periphery of the cylindrical stator core 4, and a stator coil 6 is wound around each of the teeth 5. The lower part of FIG. 1 illustrates a cross section of the motor 2 taken along the line A-A in the upper part of the drawing. A lead wire 7 of the stator coil 6 extends in parallel with the Z axis. One end portion (bus bar tip portion 8a described later) of a bus bar 8 is joined to the lead wire 7, and the other end portion 8b of the bus bar 8 extends to the outside of the housing 3. A terminal block 3a is provided at the outer periphery of the housing 3, and the other end portion 8b of the bus bar 8 is fixed to the terminal block 3a with a bolt 9. At the terminal block 3a, the bus bar 8 is connected to a power line (not illustrated) extending from an inverter.

The motor 2 includes at least three stator coils, and a bus bar is connected to each of two lead wires of each of the stator coils. In FIG. 1, only one lead wire 7 and bus bar 8 are illustrated, and the other lead wires and bus bars are not illustrated. The structure in the vicinity of the joint portion between the lead wire 7 and the bus bar 8 will be described in detail below. The lead wire 7 and the bus bar 8 are welded together, and the joint portion between the lead wire 7 and the bus bar 8 will be hereinafter referred to as a welded portion 20.

The lead wire 7 and one end portion of the bus bar 8 are held in parallel with each other and are welded together. Hereinafter, for convenience of description, one end portion of the bus bar 8 will be referred to as a bus bar tip portion 8a. A varnish receiving member 10 is attached to the lead wire 7 and the bus bar tip portion 8a. The varnish receiving member 10 has a through hole 11 and a slot 12 connected to the through hole 11, and the lead wire 7 and the bus bar tip portion 8a pass through the slot 12. As illustrated in the drawing, the width of the slot 12 is smaller than that of the welded portion 20 and larger than that of the lead wire 7 and the bus bar 8. That is, the lead wire 7 and the bus bar 8 can pass through the slot 12, but the welded portion 20 cannot pass through the slot 12. The through hole 11 is larger than the welded portion 20, and the welded portion 20 can pass through the through hole 11. The structure of the varnish receiving member 10 in FIG. 1 is obtained by passing the welded portion 20 through the through hole 11, and then moving the lead wire 7 and the bus bar tip portion 8a into the slot 12.

The welded portion 20 is covered with a varnish coating 21, and the coating 21 also covers the lead wire 7 and the bus bar tip portion 8a between the welded portion 20 and the varnish receiving member 10. A part of the coating 21 even reaches the varnish receiving member 10. That is, the welded portion 20 is covered with the varnish coating 21, and the coating 21 also covers a part of the varnish receiving member 10. The varnish coating 21 also covers the lead wire 7 and the bus bar tip portion 8a between the welded portion 20 and the varnish receiving member 10. The varnish coating 21 protects the welded portion 20 and also increases the strength of the welded portion 20.

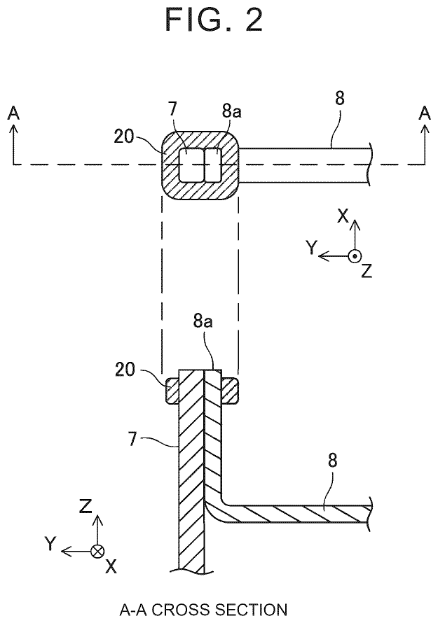

A method of manufacturing the motor 2 will be described with reference to FIGS. 2 to 4. In the following, the process from welding the lead wire 7 and the bus bar tip portion 8a to solidifying the varnish will be particularly described. In FIGS. 2 to 4, only the vicinity of the lead wire 7 and the bus bar tip portion 8a is depicted. The upper part of FIGS. 2 to 4 illustrates the welded portion 20 as viewed along the axis (Z axis) of the motor 2, and the lower part of FIGS. 2 to 4 illustrates a cross-sectional view taken along the line A-A in the upper part of the drawing.

A first step of manufacturing the motor 2 will be described. The lead wire 7 of the stator coil 6 and the bus bar tip portion 8a are welded while being held in parallel with each other (FIG. 2). The Z axis of the coordinate system in the drawing is parallel to the lead wire 7. In the welding step, the lead wire 7 and the bus bar tip portion 8a are welded together such that the size of the welded portion 20 between the lead wire 7 and the bus bar tip portion 8a is larger than the total area of the lead wire 7 and the bus bar tip portion 8a when viewed along the lead wire 7 (when viewed along the Z axis of the coordinate system in the drawing).

Next, a second step of manufacturing the motor 2 will be described. In the second step, the varnish receiving member 10 is prepared. The varnish receiving member 10 is prepared in advance, and the wording “the varnish receiving member 10 is prepared” in the second step means that the varnish receiving member 10 is used in the second step. The varnish receiving member 10 has a through hole 11 and a slot 12 connected to the through hole. The opening of the through hole 11 and the opening of the slot 12 are connected. The diameter of the through hole 11 is greater than the width of the slot 12. The through hole 11 is shaped to be sized to allow passage of the welded portion 20. As described above, the width of the slot 12 is smaller than that of the welded portion 20 and larger than that of the lead wire 7 and the bus bar 8. In other words, the width of the slot 12 is sized so as not to allow passage of the welded portion 20 but to allow passage of the lead wire 7 and the bus bar tip portion 8a. The varnish receiving member 10 is made of an insulating resin.

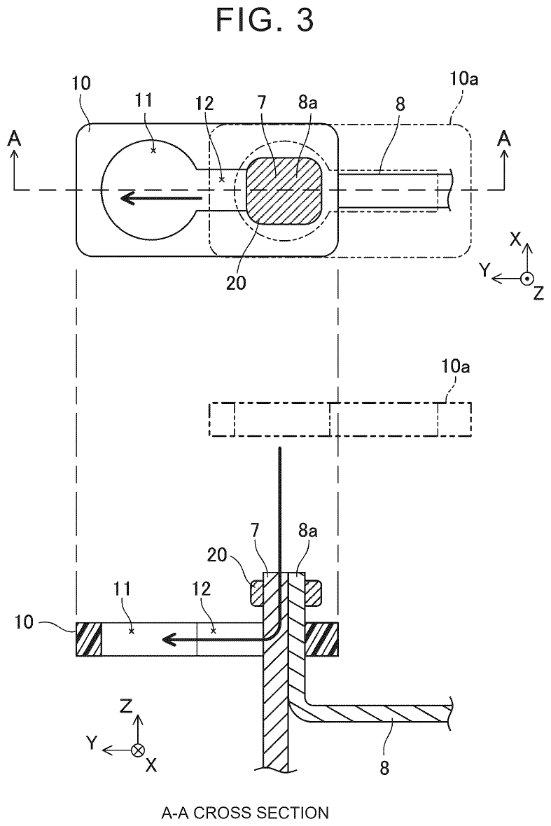

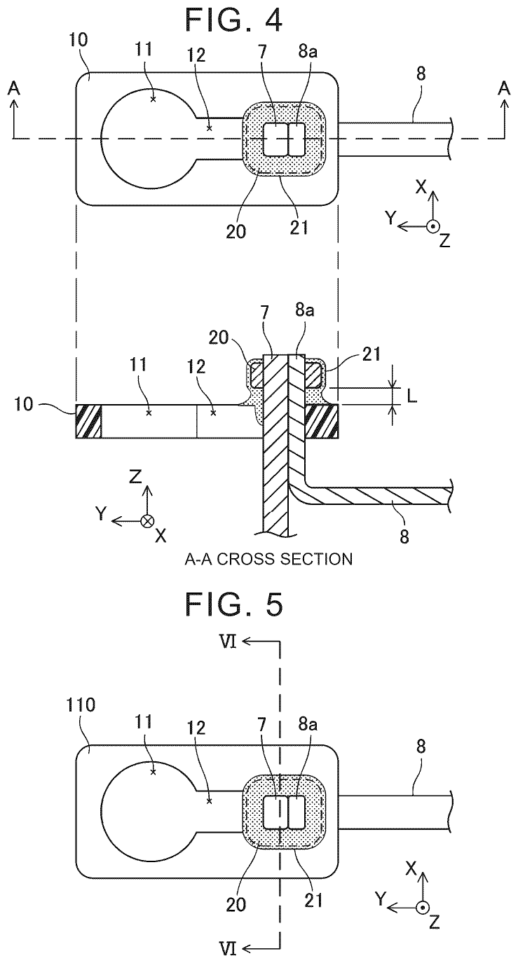

In the second step, after the welded portion 20 is passed through the through hole 11 of the varnish receiving member 10, the lead wire 7 and the bus bar tip portion 8a are moved to the end of the slot 12 (the end opposite the through hole 11) (FIG. 3). In FIG. 3, the varnish receiving member 10a drawn by the imaginary line indicates the varnish receiving member before approaching the welded portion 20, and the thick arrow line indicates the movement trajectory of the varnish receiving member 10. In the second step, the varnish receiving member 10 may be moved with the welded portion 20 fixed, or the welded portion 20 (i.e., the entire motor) may be moved with the varnish receiving member 10 fixed. [26] Next, a third step of manufacturing the motor 2 will be described. While the welded portion 20 and the varnish receiving member 10 are held in a posture in which the welded portion 20 is positioned above the varnish receiving member 10, a fluid varnish is applied to the welded portion 20 and the varnish is allowed to solidify (FIG. 4). In the third step, the posture of the welded portion 20 and the varnish receiving member 10 is kept such that the Z axis in FIG. 4 is directed in the vertical direction and +Z faces vertically upward. Then, a varnish is applied to the welded portion 20. Immediately after the application, the varnish is fluid. A part of the fluid varnish flows from the welded portion 20 along the lead wire 7 and the bus bar tip portion 8a and reaches the upper surface of the varnish receiving member 10. The part of the varnish is blocked on the varnish receiving member 10. When the varnish receiving member 10 is not used, a large amount of the varnish drips and adheres to the stator core or the like. The manufacturing method of the first embodiment employs the varnish receiving member 10, thereby making it possible to reduce the amount of a varnish dripping onto the stator core or the like compared to conventional methods. After the varnish is applied, the varnish is allowed to solidify. The solidified varnish is the varnish coating 21.

The symbol L in FIG. 4 indicates the distance between the varnish receiving member 10 and the welded portion 20. When moving the varnish receiving member 10 in the second step, the varnish receiving member 10 is preferably positioned such that the distance L between the welded portion 20 and the varnish receiving member 10 is as short as possible. Due to the surface tension of the varnish, a large amount of the varnish remains between the welded portion 20 and the varnish receiving member 10. As a result, the amount of a varnish dripping onto the stator core or the like can be more effectively reduced. When possible, in the second step, the varnish receiving member 10 is preferably moved such that the welded portion 20 comes into contact with the varnish receiving member 10.

A varnish receiving member 110 according to a modification will be described.

FIG. 5 is a plan view of the varnish receiving member 110. FIG. 5 also illustrates the lead wire 7 and the bus bar tip portion 8a welded at the welded portion 20. As described above, the lead wire 7 and the bus bar tip portion 8a are moved into the slot 12 after the welded portion 20 is passed through the large-diameter through hole 11.

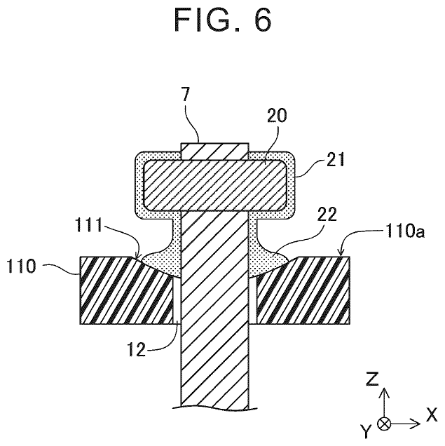

FIG. 6 is a cross-sectional view of the varnish receiving member 110 taken along the line VI-VI in FIG. 5. The varnish receiving member 110 has a depression 111 depressed from an upper surface 110a of the varnish receiving member 110. In other words, the varnish receiving member 110 has a depression 111 in the surface facing the welded portion 20. The end of the slot 12 reaches the depression 111. The lead wire 7 and the bus bar tip portion 8a pass through the depression 111. In the third step in which the varnish receiving member 110 is used, a varnish is applied in a state in which the member is held such that the depression 111 is positioned below the welded portion 20 in the vertical direction. A part of the varnish applied to the welded portion 20 flows along the lead wire 7 and the bus bar tip portion 8a and reaches the depression 111. A varnish pool 22 is formed in the depression 111. Even when a large amount of the varnish drips onto the varnish receiving member 110 in the third step, the varnish remains in the depression 111 and does not drip down. The solidified varnish is the varnish coating 21.

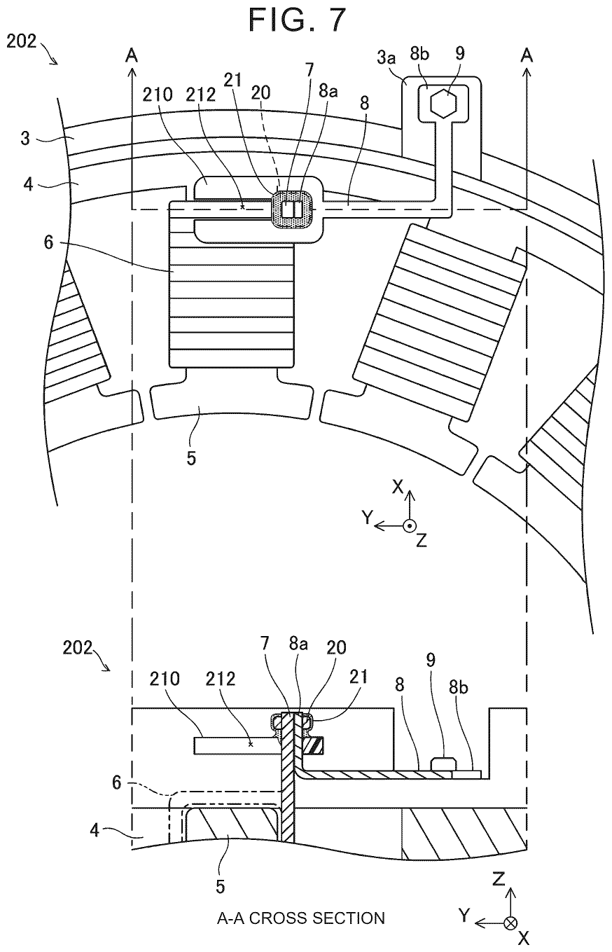

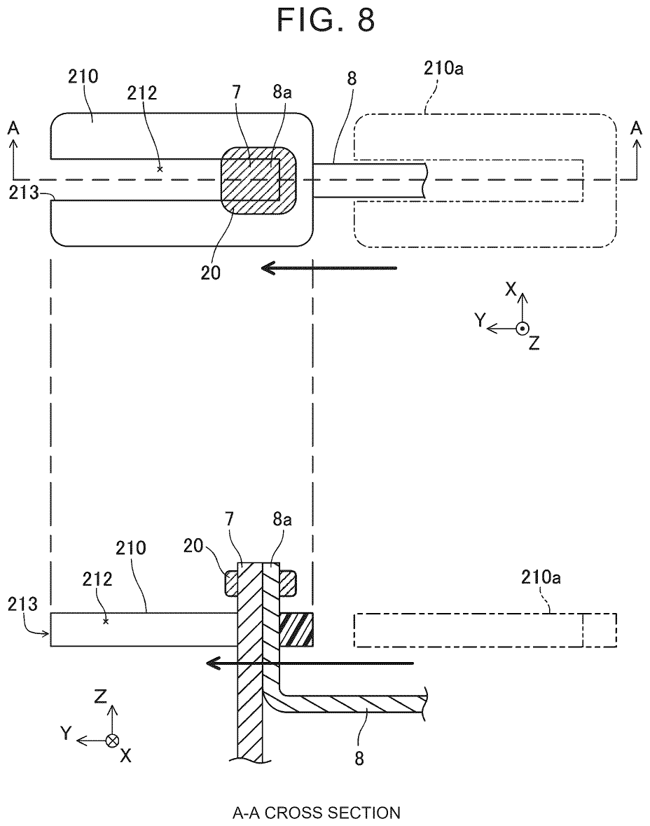

Subsequently, a motor 202 according to a second embodiment will be described with reference to FIGS. 7 and 8. FIG. 7 is a plan view of the motor 202 with a cover removed. The motor 202 of the second embodiment has the same structure as the motor 2 of the first embodiment, except for a varnish receiving member 210. The lower part of FIG. 7 illustrates a cross section of the motor 202 taken along the line A-A in the upper part of the drawing. The varnish receiving member 10 of the motor 2 in the first embodiment has the through hole 11 and the slot 12, both ends of which are closed. The varnish receiving member 210 of the motor 202 of the second embodiment does not have a through hole, but has a slot 212. The slot 212 is closed at the right end in FIG. 7, but is open at the left end. In other words, the varnish receiving member 210 has a U-shape.

The lead wire 7 and one end portion of the bus bar 8 are held in parallel with each other and are welded together. Here again, for convenience of description, one end portion of the bus bar 8 will be referred to as a bus bar tip portion 8a. A varnish receiving member 210 is attached to the lead wire 7 and the bus bar tip portion 8a. The lead wire 7 and the bus bar tip portion 8a pass through the slot 212 of the varnish receiving member 210.

The welded portion 20 is covered with a varnish coating 21, and the coating 21 also covers the lead wire 7 and the bus bar tip portion 8a between the welded portion 20 and the varnish receiving member 210. A part of the coating 21 even reaches the varnish receiving member 210. The varnish coating 21 also covers the lead wire 7 and the bus bar tip portion 8a between the welded portion 20 and the varnish receiving member 210. The varnish coating 21 protects the welded portion 20 and also increases the strength of the welded portion 20.

Subsequently, a method of manufacturing the motor 202 will be described. Also for the motor 202, the method includes a first step (welding the lead wire 7 and the bus bar tip portion 8a), a second step (attaching the varnish receiving member 210), and a third step (applying and solidifying the varnish). The first and third steps are the same as those in the first embodiment, and therefore a description thereof will be omitted. FIG. 8 illustrates the second step.

In the second step of the manufacturing method of the first embodiment, after the welded portion 20 is passed through the through hole 11 of the varnish receiving member 10, the lead wire 7 and the bus bar tip portion 8a are moved to the end of the slot 12 (the end opposite the through hole 11) (FIG. 3). For the motor 202 of the second embodiment, a varnish receiving member 210 having a slot 212 that is open at one end (the left end in FIG. 8) is prepared. Hereinafter, for convenience of description, the open end of the slot 212 will be referred to as an open end 213. In the second step of the manufacturing method of the second embodiment, the lead wire 7 and the bus bar 8 are inserted into the slot 212 through the open end 213. In FIG. 8, a varnish receiving member 210a drawn by the imaginary line indicates the varnish receiving member before being attached to the lead wire 7 and the bus bar 8, and the thick arrow line indicates the movement trajectory of the varnish receiving member 210. Since the slot 212 has an open end 213, the varnish receiving member 210 can be easily set by moving the varnish receiving member 210 such that the lead wire 7 and the bus bar 8 are inserted into the slot 212.

In the second step, the varnish receiving member 210 may be moved with the welded portion 20 fixed, or the welded portion 20 (i.e., the entire motor) may be moved with the varnish receiving member 210 fixed. After the varnish receiving member 210 is attached to the lead wire 7 and the bus bar 8, a varnish is applied to the welded portion 20 and allowed to solidify (FIG. 4).

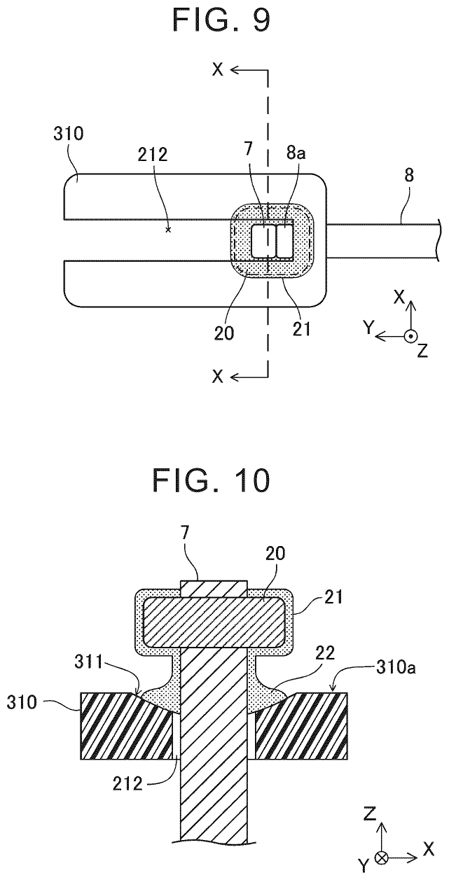

Subsequently, a modification of the varnish receiving member 210 will be described. FIG. 9 is a plan view of a varnish receiving member 310 according to the modification. FIG. 9 also illustrates the lead wire 7 and the bus bar tip portion 8a welded at the welded portion 20. The lead wire 7 and the bus bar tip portion 8a pass through a slot 312 of the varnish receiving member 310. FIG. 10 is a cross-sectional view of the varnish receiving member 310 taken along the line X-X in FIG. 9. The varnish receiving member 310 has a depression 311 depressed from an upper surface 310a of the varnish receiving member 310. In other words, the varnish receiving member 310 has a depression 311 in the surface facing the welded portion 20. The end of the slot 312 reaches the depression 311. The lead wire 7 and the bus bar tip portion 8a pass through the depression 311. In the third step in which the varnish receiving member 310 is used, a varnish is applied in a state in which the member is held such that the depression 311 is positioned below the welded portion 20 in the vertical direction. A part of the varnish applied to the welded portion 20 flows along the lead wire 7 and the bus bar tip portion 8a and reaches the depression 311. A varnish pool 22 is formed in the depression 311. Even when a large amount of the varnish drips onto the varnish receiving member 310 in the third step, the varnish remains in the depression 311 and does not drip down. The solidified varnish is the varnish coating 21.

Points to note regarding the technology described in the first and second embodiments will be described. Although the through hole 11 of the varnish receiving member 10 (110) is circular, the through hole does not have to be circular. It is only necessary that the through hole should be shaped to be sized to allow passage of the welded portion 20. It is desirable that the width of the slot 12 (212) should be the same as the width of one of the lead wire 7 and the bus bar tip portion 8a that is the larger. In other words, at least one of the lead wire 7 and the bus bar tip portion 8a is preferably in contact with the inner surface of the slot 12 (212). The lead wire 7 or the bus bar tip portion 8a is preferably in contact with the inner surface of the slot 12 (212). The amount of the varnish dripping down through the gap between the lead wire 7 (or the bus bar tip portion 8a) and the slot 12 can be reduced.

At least one of the lead wire 7 and the bus bar tip portion 8a is preferably positioned so as to be in contact with the end (the end opposite the through hole) of the slot 12 (212). This suppresses the varnish dripping down through the gap between the lead wire 7 (or the bus bar tip portion 8a) and the end of the slot 12 (212).

In the third step, the posture of the varnish receiving member 10 and the welded portion 20 is held such that the welded portion 20 is positioned vertically above the varnish receiving member 10 (210). The first and second steps may be performed in any posture.

In the drawings, only one lead wire 7 and one bus bar 8 are illustrated. The stator includes at least three coils and at least six lead wires. Each of the lead wires may be provided with a varnish receiving member. It is only necessary that at least one of the lead wires should be provided with a varnish receiving member.

Although the specific examples of the present disclosure have been described in detail above, these are merely examples and do not limit the scope of the claims. The technologies set forth in the claims include various modifications and alternations of the specific examples indicated above. The technical elements described in the present specification or illustrated the drawings exhibit technical utility alone or in various combinations, and are not limited to the combinations set forth in the claims as originally filed. Furthermore, the technologies indicated in the present specification or the drawings can achieve a plurality of objects at the same time, and achieving one of such objects itself has technical utility.

What is claimed is:

1. A method of manufacturing an electric motor, the method comprising:
a first step of welding a lead wire of a stator coil and a tip portion of a bus bar while holding the lead wire and the tip portion in parallel with each other;
a second step of preparing a varnish receiving member having a slot having a width smaller than that of a welded portion between the lead wire and the bus bar and larger than those of the lead wire and the bus bar, and attaching the varnish receiving member such that the lead wire and the bus bar pass through the slot; and
a third step of applying a varnish that is fluid to the welded portion while holding the welded portion and the varnish receiving member in a posture in which the welded portion is positioned above the varnish receiving member, and solidifying the varnish.

2. The method of manufacturing an electric motor according to claim 1, wherein:
the varnish receiving member has a through hole connected to the slot, the through hole being shaped to be sized to allow passage of the welded portion; and
the second step includes passing the welded portion through the through hole and then moving the lead wire and the bus bar into the slot.

3. The method of manufacturing an electric motor according to claim 2, wherein the through hole is circular in shape.

4. The method of manufacturing an electric motor according to claim 1, wherein the second step includes moving the varnish receiving member with the welded portion fixed.

5. The method of manufacturing an electric motor according to claim 1, wherein the second step includes moving the welded portion with the varnish receiving member fixed.

6. The method of manufacturing an electric motor according to claim 1, wherein:
the slot is open at one end; and
the second step includes placing the lead wire and the bus bar into the slot through the one end.

7. The method of manufacturing an electric motor according to claim 1, wherein:
the varnish receiving member has a depression depressed from an upper surface of the varnish receiving member; and
the third step includes applying the varnish in a state in which the varnish receiving member is held such that the depression is positioned below the welded portion in a vertical direction.

8. An electric motor comprising:
a stator coil;
a bus bar, a tip portion of which being welded to a lead wire of the stator coil; and
a varnish receiving member having a slot having a width smaller than that of a welded portion between the lead wire and the bus bar and larger than those of the lead wire and the bus bar, the lead wire and the bus bar passing through the slot, wherein
the welded portion between the bus bar and the lead wire and a part of the slot are covered with a varnish.

9. The electric motor according to claim 8, wherein the varnish receiving member has a through hole connected to the slot, the through hole being shaped to be sized to allow passage of the welded portion.

10. The electric motor according to claim 9, wherein the through hole is circular in shape.

11. The electric motor according to claim 8, wherein the slot is open at one end.

12. The electric motor according to claim 8, wherein the varnish receiving member has a depression depressed from an upper surface of the varnish receiving member.
